(19) United States
(12) Patent Application Publication
(10) Pub. No.: US 2009/0236783 A1
(43) Pub. Date: Sep. 24, 2009

(54) Gas Spring

(75) Inventors: Frank Doffing, Kastellaun (DE); Rainer Massmann, Bonn (DE); Rolf Mintgen, Thuer (DE); Mihai Augustin Vidrean, Sighisoara (RO)

Correspondence Address: COHEN, PONTANI, LIEBERMAN & PAVANE LLP, 551 FIFTH AVENUE, SUITE 1210, NEW YORK, NY, 10176, US

(73) Assignee: Stabilus GmbH, Koblenz (DE)

(21) Appl. No.: 12/407,040

(22) Filed: Mar. 19, 2009

(30) Foreign Application Priority Data
Mar. 20, 2008 (DE) 10 2008 015 314.1
Dec. 11, 2008 (DE) 10 2008 061 814.4

(51) Int. Cl. F16F 9/02

(52) U.S. Cl. 267/124

(57) ABSTRACT

A gas spring includes a center longitudinal axis and a closed first end, a cylinder filled with gas under pressure, a piston displaceably arranged in the cylinder and dividing the cylinder into a first work chamber near the closed end and a second work chamber remote of the closed end, a piston rod passing through the second work chamber and guided out of the cylinder through a guiding and sealing device, and a mechanical blocking device whose action depends upon the internal pressure. The piston has a piston chamber connected to the outside of the cylinder. A first safety element and a second safety element form the mechanical blocking device. The first safety element connects the first work chamber to the outside via the piston chamber when the pressure in the cylinder is too low and brings the second safety element into contact with the inner wall of the cylinder.

The invention is directed to a gas spring with a center longitudinal axis and a closed first end, a cylinder which is filled with a fluid under pressure, a piston which is displaceably arranged in the cylinder and which divides the cylinder into a first work chamber near the closed end and a second work chamber remote of the closed end, and a piston rod which is arranged on one side of the piston, penetrates the second work chamber and is guided out of the cylinder through a guiding and sealing device so as to be sealed.

A gas spring with a mechanical blocking device whose action depends upon internal pressure is known from German Patent DE 28 55 560 C2. The blocking device has a clamping body acting between a cylinder and piston rod. To form the blocking device, the piston comprises a pressure gas space formed by a ring piston and a piston cylinder which are displaceable relative to one another and are sealed by a seal, while the piston rod is guided through the piston so as to be sealed by seals and its ring piston and piston cylinder are displaceable on the piston rod, and the piston is supported by spring elements at stop bodies which are fixedly connected to the piston rod, a clamping body cooperating with the inner wall of the cylinder being arranged therebetween.

DE 36 17 726 C2 shows a gas spring with a deformable chamber whose interior space can be connected to the two work chambers of the gas spring by a flap valve. The flap valve is opened when the pressure in one of the work chambers is greater than a predefined pressure value in the deformable chamber. The flap valve is closed when there is a drop in pressure in the work chambers. Due to the difference in pressure which then exists between the work chambers of the gas spring and the deformable chamber, the wall of the deformable chamber is forced against either the piston rod or the inner wall of the work chambers so that the piston rod and piston are blocked.

It is the object of the invention to provide a gas spring of the type mentioned above which provides a mechanical fail safe becoming operative when there is a drop in gas pressure and which has a simple construction.

This object is met according to the invention in that the piston has a piston chamber which is connected to, or can be connected to, the outer environment of the cylinder, and a first safety element and a second safety element form the mechanical blocking device, wherein the first safety element connects the first work chamber to the outer environment via the piston chamber when the pressure in the cylinder is too low and brings the second safety element into contact with the inner wall of the cylinder.

In another construction, a second aperture located opposite from the first aperture is provided in the piston chamber and connects the piston chamber to the first work chamber.

A spring element is arranged in the piston chamber in order to pretension the first safety element axially in direction of the first work chamber by means of a slide.

The first safety element advantageously comprises a valve pin.

In another construction, a sealing element is arranged at the second aperture, the valve pin closing the second aperture by means of the sealing element such that it can open toward the first work chamber.

At least one sealing element is arranged at the first aperture so that the second aperture is closed tight against gas, and the valve pin closes the first aperture by means of this at least one sealing element such that the first aperture can open toward the bore hole of the piston rod.

In another construction, the second safety element comprises arms extending from the piston into the first work chamber.

Each arm has at its end remote of the piston a projection which narrows in diameter toward the piston so that an inclined surface is formed which is in operative connection with the first safety element.

Alternatively, the second safety element comprises a clamping element, preferably a plurality of clamping elements.

Every clamping element advantageously has a groove at the side facing the inner wall, an elastic ring element which pretensions the clamping elements radial to the center longitudinal axis being inserted into the groove.

In another construction, the clamping elements are fastened to the piston by means of wires so that the clamping elements are connected to the piston.

One or more circumferential inclined surfaces are formed one behind the other in axial direction at the side facing the center longitudinal axis.

In another construction, a clamping sleeve is arranged opposite the inclined surfaces so as to be concentric to the center longitudinal axis, this clamping sleeve having inclined surfaces which are formed so as to complement the other inclined surfaces.

The inclined surfaces are arranged at a defined distance from one another and form a ring-shaped intermediate space in which bearing elements in the form of balls or rollers are arranged.

In an advantageous construction, at least one supporting arm extends from the piston in direction of the first end of the cylinder, a holding element being arranged at its free end, which holding element is provided in turn as an axial stop for the clamping elements when the piston or piston rod moves in outward direction, wherein the supporting arm has, at the side facing the inner wall, a groove in which the ring element is arranged.

In an alternative construction, the first aperture connecting the piston chamber formed in the piston to the second work chamber has three portions with different inner diameters.

In another construction, the first portion remote of the piston chamber has an inner diameter which substantially corresponds to the outer diameter of the piston rod, one end of the hollow piston rod being inserted into the first portion, and material of the piston is folded into a radially circumferential groove arranged in the piston rod in order to connect the piston to the piston rod.

Following the first portion is a second portion with a smaller inner diameter in which a supporting ring and an O-ring seal are arranged, and the second portion is adjoined by a third portion with a further reduced inner diameter which directly communicates with the piston chamber, the three portions forming a step-shaped construction by means of the different inner diameters.

In an alternative embodiment form, the second aperture has a diameter which corresponds to the diameter of the piston chamber, and a circular space which is formed coaxial to the center longitudinal line in direction of the first work chamber and in which the slide is arranged adjoins the piston chamber.

In another construction, the space has a greater diameter than the piston chamber so that a step is formed at the transition from the space to the piston chamber, this step being contacted by the slide in normal operation.

Further, one or more supporting arms extend into the second work chamber from an annular wall surrounding the space, projections being provided at the free ends of the supporting arms.

In another embodiment form, the valve pin formed at the wedge element extends through the slide, the piston chamber and the three portions of the first aperture in direction of the piston rod, and the end of the valve pin facing the piston rod has an axial groove or flattened portion which is located in the first portion of the first aperture in normal operation.

Embodiment examples of the invention are shown in the drawings and are described more fully in the following.

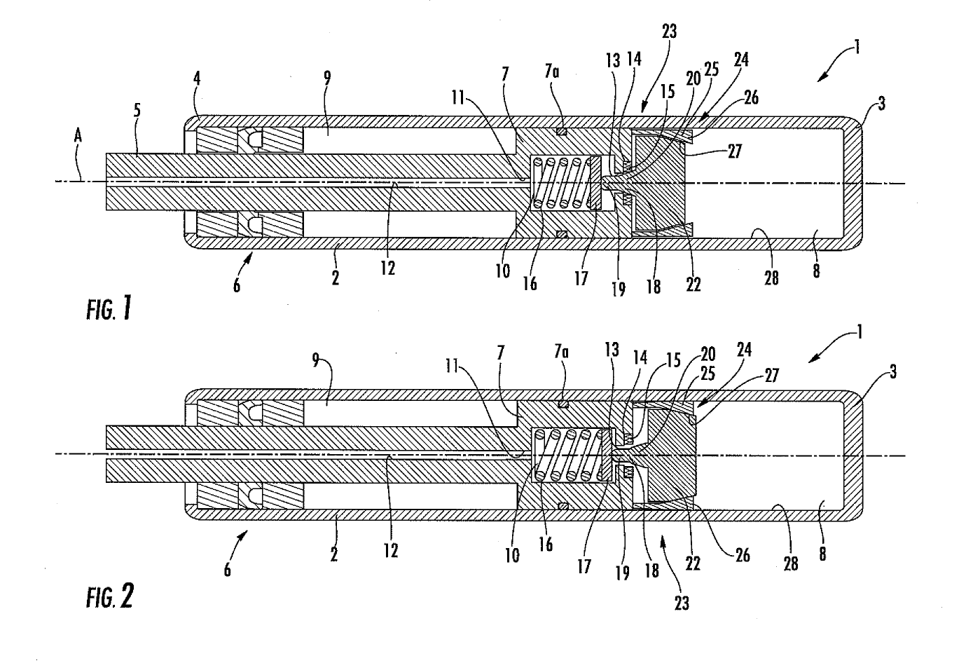

FIG. 1 shows a longitudinal section through a gas spring according to the invention in normal operation;

FIG. 2 shows a longitudinal section through the gas spring shown in FIG. 1 during a drop in pressure;

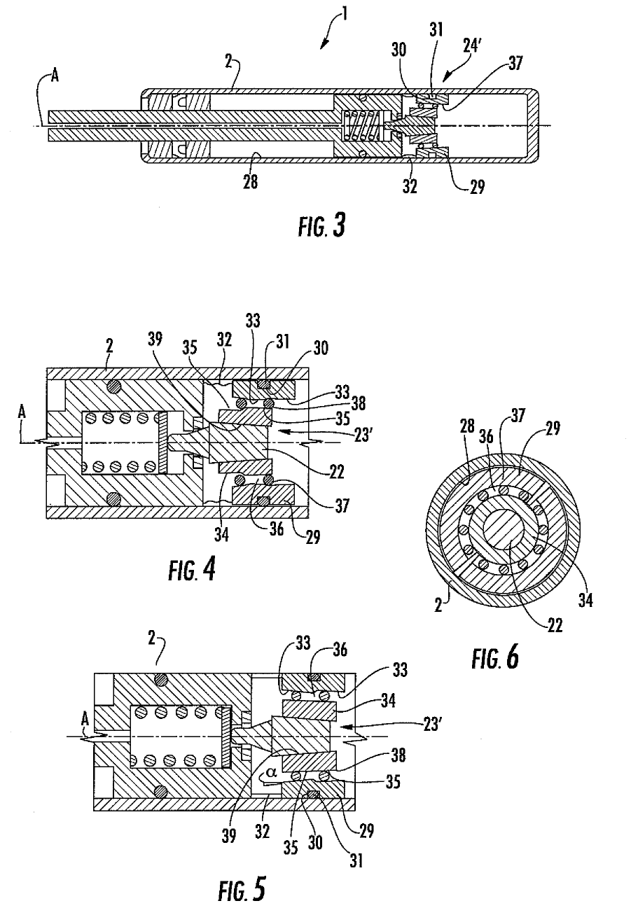

FIG. 3 shows a longitudinal section of another embodiment form of a gas spring according to the invention in normal operation;

FIG. 4 shows a detailed view of the gas spring shown in FIG. 3 in normal operation;

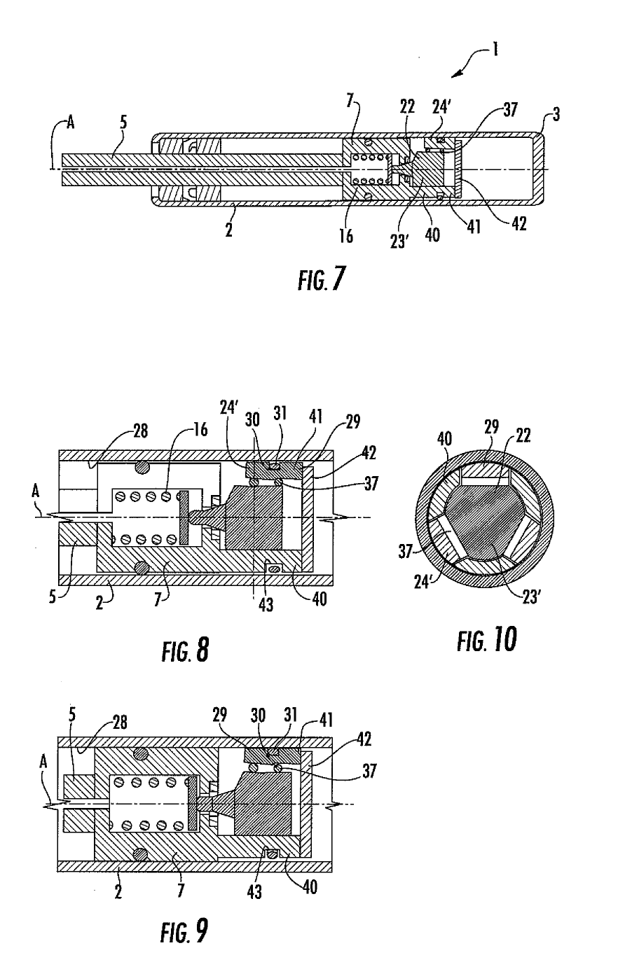

FIG. 5 shows a detailed view of the gas spring shown in FIG. 3 during a drop in pressure;

FIG. 6 shows a cross section through the gas spring shown in FIG. 3;

FIG. 7 shows a longitudinal section through another embodiment form of a gas spring according to the invention in normal operation;

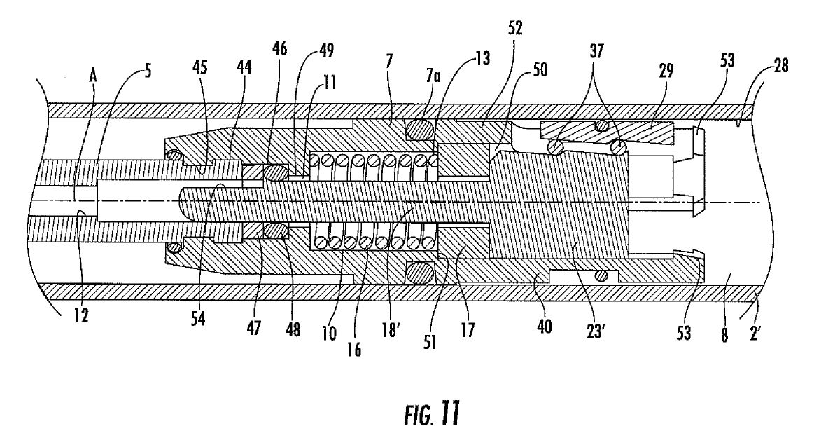

FIG. 8 shows a detailed view of the gas spring shown in FIG. 7 in normal operation;

FIG. 9 shows a detailed view of the gas spring shown in FIG. 7 during a drop in pressure;

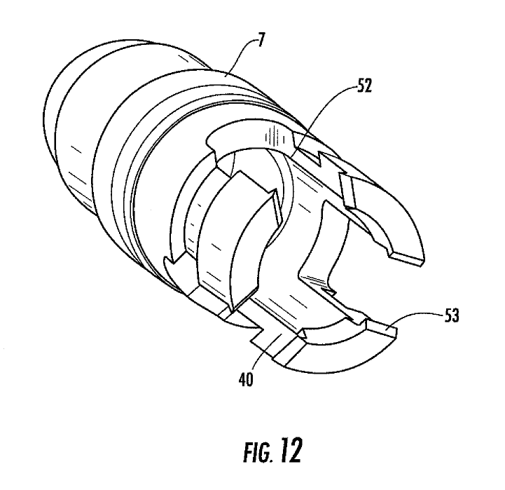

FIG. 10 shows a cross section through the gas spring shown in FIG. 7;

FIG. 11 shows a detailed view of another embodiment form according to the invention in longitudinal section; and

FIG. 12 shows a three-dimensional view of a structural component part shown in FIG. 11.

FIGS. 1 and 2 show a piston-cylinder unit in the form of a gas spring 1 comprising a cylinder 2 with a closed first end 3 and a second end 4 opposite from the closed end 3. A piston rod 5 is guided out of the cylinder 2 in a sealed manner concentric to a center longitudinal axis A of the gas spring 1 through the second end 4 by means of a guiding and sealing device 6.

Normally, a connection element, not shown, in the form of a ball socket or knuckle eye is arranged at the closed end 3 of the cylinder 2, and another connection element, not shown, by which the gas spring 1 is fastened between two parts which are movable relative to one another, for example, a hatch and a body of a motor vehicle, is arranged at the end of the piston rod 5 located outside the cylinder 2.

A piston 7 is arranged at the end of the piston rod 5 located in the cylinder 2 and divides the cylinder 2 into a first work chamber 8 and a second work chamber 9 through which the piston rod 5 extends. Overflow devices, not shown, which are assumed as known in gas springs, for example, a groove extending in axial direction in the cylinder 2 or a piston ring under which flow can occur, can be provided so that the gas which is under pressure in the cylinder 2 can flow from one work chamber into the other. The piston ring shown in the drawings is a simple O-ring 7a.

A piston chamber 10 is formed in the piston 7 and has, at the side of the piston 7 facing the second work chamber 9, a first aperture 10 which is arranged concentric to the center longitudinal axis A and which opens into a bore hole 12 extending through the piston rod 5. A second aperture 13 formed concentric to the center longitudinal axis is provided on the side opposite from the first aperture 11 and joins the piston chamber 10 with the first work chamber 8. On the side facing the first work chamber 8, the second aperture 13 has a widened diameter 14 in which a sealing element 15 is arranged.

Arranged in the piston chamber 10 is a spring element 16 which contacts the inner wall of the piston chamber 10 facing the second work chamber 9 and contacts a disk-shaped slide 17 on the opposite side. The slide 17 in turn contacts a valve pin 18 or is connected integral with it. The valve pin 18 extends from the piston chamber 10 through the second aperture 13 into the first work chamber 8 and comprises a first portion 19 having a small diameter, the diameter of the first portion 19 being at least slightly smaller than the inner diameter of the second aperture 13, and a second conically shaped portion 20.

At the side opposite the first portion 19, the second portion 20 of the valve pin 18 is connected to a truncated-cone-shaped wedge element 22 which, together with the valve pin 18, forms a first safety element 23. The valve pin 18 and the wedge element 22 can be screwed, glued, or welded together, for example. It is also possible for the valve pin 18 and wedge element 22 to be formed integral with one another.

A plurality of arms 25 forming a second safety element 24 extend from the piston 7 into the second work chamber 9. The arms 25 have a projection 26 at their ends remote of the piston 7. The projection 26 narrows in diameter toward the piston 7 so as to form an inclined surface 27 in operative connection with the first safety element 23.

In normal operation, as is shown in FIG. 1, the second portion 20 of the valve pin 18 is tightly pressed against the sealing element 15 by the gas pressure in the gas spring.

When there is a decrease in gas pressure, for example, due to lost gas, the force of the spring element 16 arranged in the piston chamber 10 is greater than the effective gas force acting on the valve pin 18. As is shown in FIG. 2, the valve pin 18 is moved axially in direction of the first end 3 of the cylinder 2 and the conical second portion 20 is lifted from the sealing element 15. In this way, an immediate area compensation is brought about at the valve pin 18 so that the acting gas force is not dependent on direction and the force of the spring element 16 moves the valve pin 18 quickly in direction of the first end 3 of the cylinder 2 without an opposing force being exerted by the gas pressure.

The first safety element 23 formed by the valve pin 18 and wedge element 22 is displaced by the force of the spring element 16 against the inclined surfaces 27 of the arms 25 and moves the latter radially against the inner wall 28 of the cylinder 2 so that there is a drastic increase in friction and, accordingly, a blocking of the piston 7 and, therefore, of the piston rod 5 is carried out.

In the embodiment form shown in FIGS. 3 to 6, the second safety element 24′ comprises a plurality of clamping elements 29 arranged circumferentially near the inner wall 28. Each of the clamping elements 29 has a groove 30 on the side facing the inner wall 28, an elastic ring element 31, for example, an O-ring made of an elastomer or an annular spring, being inserted into the groove 30. The ring element 31 pretensions the clamping elements 29 radially inward and is inserted into the groove 30 to a depth such that the ring element 31 does not touch the inner wall 28 of the cylinder 2 even when the clamping elements 29 are moved in radial direction against the inner wall 28. The clamping elements 29 are fastened to the piston 7 by wires 32. Preferably two circumferential inclined surfaces 33 are formed one behind the other at the side facing the center longitudinal axis A.

Opposite the inclined surfaces 33, a clamping sleeve 34 having inclined surfaces 35 complementing the inclined surfaces 33 is arranged concentric to the center longitudinal axis A. The clamping sleeve 34, together with the wedge element 22 and valve pin 18, forms the first safety element 23′. The inclined surfaces 33 and 35 are arranged at a defined distance from one another and form a ring-shaped intermediate space 36 in which bearing elements 37 in the form of balls or rollers are arranged. The inclined surfaces 33 and 35 are constructed in such a way that the bearing elements 37 cannot fall out of the intermediate space 36. For this purpose, a collar 38, for example, which can be contacted by the bearing elements is formed at the ends of the inclined surfaces 33 and 35. Further, the clamping sleeve 34 has an inner cone 39 fitted to the wedge element 22.

In the event of a drop in pressure due to the escape of gas from the cylinder 2, the spring element 16 moves the valve pin 18 and, therefore, the wedge element 22 and clamping sleeve 34 along the center longitudinal axis A in direction of the first end 3 of the cylinder 2 as is shown in FIG. 5. At the same time, the piston 7 with the piston rod 5 moves into the cylinder 2. A self-reinforcing clamping at the inner wall 28 is produced in this way by the clamping elements 29 which are fixedly connected to the piston 7 in the pull direction by the wires 32. In doing so, the bearing elements 37 reduce the friction between the clamping sleeve 34 and the clamping elements 29. The self-reinforcement of the clamping elements 29 occurs when the friction angle between the outer clamping elements 29 and the inner wall 28 of the cylinder 2 is greater than the sum of the friction angle between the clamping sleeve 34 and clamping elements 29 and the selected angle of inclination or wedge angle α.

FIGS. 7 to 10 show another embodiment form of the invention in which the wedge element 22 and the clamping sleeve 34 shown in FIGS. 3 to 6 are formed integral with one another. Three supporting arms 40 extend from the piston 7 in direction of the first end 3 of the cylinder 2, a holding element 42 being arranged at their free ends 41. The holding element 42 is provided in turn as an axial stop for the clamping elements 29 when the piston 7 and piston rod 5 move in the outward direction. The supporting arms 40 have a groove 43 on the side facing the inner wall 28. In this embodiment example, the ring element 31 is arranged in the grooves 30 of the clamping elements 29 and in the grooves 43 of the supporting arms 40.

As is shown in FIG. 10, the bearing elements 37 are constructed as rollers and the first safety element 23′ has, in the area where it cooperates with the second safety element 24′, a cross section substantially corresponding to the shape of a triangle with rounded corners. In case gas escapes from the cylinder 2, the spring element 16 moves the first safety element 23′ along the center longitudinal axis A in direction of the first end 3 of the cylinder 2 as is shown in FIG. 9. At the same time, still more gas is released into the environment from the cylinder 2, and the piston 7 moves with the piston rod 5 into the cylinder 2 owing to the lost gas, and the clamping elements 29 move radially outward against the inner wall 28 of the cylinder 2 by means of the bearing elements 37. In so doing, a self-reinforcing clamping is brought about at the inner wall 28 by the clamping elements 29 which are connected to the piston 7 in the pull direction by the holding element 42.

FIG. 11 shows a detailed view of another embodiment form of the invention. The first aperture 11 which connects the piston chamber 10 formed in the piston 7 to the bore hole 12 in the piston rod 5 has three portions with different inner diameters. The first portion 44 which is remote of the piston chamber 10 has an inner diameter which substantially corresponds to the outer diameter of the piston rod 5. One end of the hollow piston rod 5 is inserted into the first portion 44. Material of the piston 7 is deformed into a radially circumferential groove 45 arranged in the piston rod to connect the piston 7 to the piston rod 5. Adjoining the first portion 44 is a second portion 46 with a smaller inner diameter in which a supporting ring 47 and an O-ring seal 48 are arranged. Adjoining the second portion 46 is a third portion 49 with a further reduced inner diameter which communicates directly with the piston chamber 10. The different inner diameters of the three portions 44, 46 and 49 form a step-shaped construction by which the supporting ring 47 and the O-ring seal 48 are fixed in axial direction.

The second aperture 13 opposite the first aperture 11 has a diameter corresponding to the diameter of the piston chamber 10. Adjoining the piston chamber 10 is a circular space 50 which is formed coaxial to the center longitudinal line A and in which the slide 17 is arranged. The space 50 has a greater diameter than the piston chamber 10 so that a step 51 is formed at the transition from the space 50 to the piston chamber 10, this step 51 being contacted by the slide 17 in normal operation. However, it can be seen that the slide 17 can be formed integral with the wedge element 22. The supporting arms 40 extend from an annular wall 52 surrounding the space 50 into the first work chamber 8. In another construction, projections 53 are provided at the free ends of the supporting arms 40, which projections 53 serve as stops for the clamping elements 29 when the piston rod 5 is moved out of the cylinder 2.

The valve pin 18′ formed at the wedge element 22 extends through the slide 17, piston chamber 10, and the three portions 44, 46 and 49 of the first aperture 11 in direction of the piston rod 5. The end of the valve pin 18′ facing the piston rod 5 has an axial groove or flattened portion 54 which is located in the first portion 44 of the first aperture 11 in normal operation.

When there is a loss of pressure, the spring element 16 moves the slide 17 and, therefore, the first safety element 23′ along the center longitudinal axis A in direction of the first work chamber 8. The groove or flattened portion 54 of the valve pin 18′ enters the second portion 46 of the aperture 11 and still more gas escapes. At the same time, the piston 7 moves with the piston rod 5 into the cylinder 2 owing to the lost gas, and the clamping elements 29 move radially outward against the inner wall 28 of the cylinder 2 by means of the bearing elements 37. In this way, a self-reinforcing clamping is brought about at the inner wall 28 by the clamping elements 29 which are connected to the piston 7 in the pull direction by the projections 53.

FIG. 12 shows the piston shown in FIG. 11 in a three-dimensional view which clearly shows the arrangement of the projections 53 at the supporting arms 40.

### REFERENCE NUMBERS

1 gas spring
2 cylinder
3 first end
4 second end
5 piston rod
6 sealing and guiding device
7 piston
7a piston ring
8 first work chamber
9 second work chamber
10 piston chamber
11 first aperture
12 bore hole
13 second aperture
14 expanded diameter
15 sealing element
16 spring element
17 slide
18 valve pin
18′ valve pin
19 first portion
20 second portion
22 wedge element
23 first safety element
23′ first safety element
24 second safety element
24′ second safety element
25 arm
26 projection
27 inclined surface
28 inner wall
29 clamping element
30 groove
31 ring element
32 wire
33 inclined surface
34 clamping sleeve
35 inclined surface
36 intermediate space
37 bearing element
38 collar
39 inner cone
40 supporting arm
41 free end
42 holding element
43 groove
44 first portion
45 groove
46 second portion
47 supporting ring
48 O-ring seal
49 third portion
50 space
51 step
52 annular wall
53 projection
54 flattened portion
A center longitudinal axis

1.-24. (canceled)

25. A gas spring comprising:
a cylinder having a central longitudinal axis, an inner wall, a closed first end, and an opposed second end, the cylinder being filled with a gas under pressure;
a piston displaceably arranged in the cylinder, the piston dividing the cylinder into a first work space adjacent to the first end and a second work space adjacent to the second end, the piston having a chamber connected to outside the cylinder;
a piston rod connected to the piston and extending through the second work chamber, the piston rod being guided out of the cylinder through a guiding and sealing device in the second end;
a first safety element which connects the first work chamber to the outside via the piston chamber when gas pressure in the first work chamber falls below a predefined threshold; and
a second safety element which contacts the inner wall of the cylinder and blocks movement of the piston when the first safety element connects the first work chamber to the outside.

26. The gas spring of claim 1 wherein the piston rod has a bore connected to outside the cylinder, the piston comprising a first aperture connecting the piston chamber to the bore.

27. The gas spring of claim 2 wherein the piston further comprises a second aperture opposite from the first aperture, the second aperture connecting the piston chamber to the first work chamber.

28. The gas spring of claim 27 further comprising a slide and a spring element arranged in the piston chamber, wherein the spring pretensions the first safety element toward the first work chamber by means of the slide.

29. The gas spring of claim 28 wherein the first safety element comprises a valve pin received in the second aperture.

30. The gas spring of claim 29 further comprising a sealing ring arranged in the second aperture, the valve pin closing the second aperture via the sealing ring when the gas pressure in the first chamber is above the predefined threshold.

31. The gas spring of claim 29 further comprising a sealing ring arranged in the first aperture, the valve pin closing the first aperture via the sealing ring when the gas pressure in the first chamber is above the predefined threshold.

32. The gas spring of claim 25 wherein the second safety element comprises arms extending from the piston into the first work chamber.

33. The gas spring of claim 32 wherein each said arm has a distal end remote from the piston and a radial thickness which decreases from the distal end toward the piston to form an inclined surface which cooperates with the first safety element.

34. The gas spring of claim 25 wherein the second safety element comprises a plurality of clamping elements, each said clamping element having a groove facing the inner wall of the cylinder, and an elastic ring element received in the grooves, the ring element loading the clamping elements radially toward the longitudinal axis.

35. The gas spring of claim 34 further comprising wires fastening the clamping elements to the piston.

36. The gas spring of claim 34 wherein each said clamping element comprises a plurality of inclined surfaces arranged axially in tandem, said inclined surfaces facing the longitudinal axis and extending at an acute angle to said axis.

37. The gas spring of claim 36 further comprising a clamping sleeve arranged concentrically between the first safety element and the clamping elements, the clamping sleeve having a plurality of inclined surfaces which complement respective said inclined surfaces of the clamping elements.

38. The gas spring of claim 37 wherein complementary said inclined surfaces are spaced apart by a radial gap, the gas spring further comprising rolling bearing elements arranged in said radial gap.

39. The gas spring of claim 34 further comprising a plurality of supporting arms arranged between the clamping elements, each said supporting arm extending from the piston to a distal end and having a groove receiving said elastic ring element, said gas spring further comprising a holding element received against the distal ends of the supporting arms and serving as an axial stop for the clamping elements.

40. The gas spring of claim 29 wherein the first aperture comprises adjoining first, second, and third portions having different diameters, the first portion being remotest from the piston chamber and having substantially the same inner diameter as the outer diameter of the piston rod, the piston rod having a circumferential groove into which the piston is deformed to connect the piston to the piston rod.

41. The gas spring of claim 40 wherein the second portion has a smaller inner diameter than the first portion, and the third portion has a smaller inner diameter than the second portion, the gas spring further comprising a supporting ring and an O-ring seal arranged in the second portion.

42. The gas spring of claim 41 wherein the second aperture has the same diameter as the piston chamber, the piston further having a circular space adjoining the second aperture and having a larger diameter than the second aperture, thereby forming a step between the circular space and the second aperture, the slide being arranged in the circular space and contacting the step.

43. The gas spring of claim 42 wherein the piston comprises an annular wall surrounding the circular space, the gas spring further comprising a plurality of supporting arms extending from the annular wall into the first work space, the valve pin extending through the slide, the piston chamber, and the three portions of the first aperture, the valve pin having a distal portion provided with a radial depression located in the first portion during normal operation.
